(19) United States
(12) Patent Application Publication
(10) Pub. No.: US 2025/0005816 A1
(43) Pub. Date: Jan. 2, 2025

(54) IMAGE PROCESSING APPARATUS, CONTROL METHOD, STORAGE MEDIUM, AND COLOR CHART

(71) Applicant: CANON KABUSHIKI KAISHA, Tokyo (JP)

(72) Inventors: YASUHIRO ITOH, Kanagawa (JP); TAKAHIRO MATSUURA, Tokyo (JP)

(21) Appl. No.: 18/752,604

(22) Filed: Jun. 24, 2024

(30) Foreign Application Priority Data
Jun. 27, 2023 (JP) 2023-105340

(51) Int. Cl. G06T 11/00; G06T 7/90; G06T 11/20

(52) U.S. Cl. CPC G06T 11/001; G06T 7/90; G06T 11/206; G06T 2200/24

(57) ABSTRACT

An image processing apparatus can include an obtaining unit configured to obtain spectral reflectances of a plurality of color patches, and a control unit configured to generate design data of a color chart including a plurality of color patches selected so as to reduce an evaluation value E of the color chart calculated based on Equation (I) from the spectral reflectances of the plurality of color patches.
(Rm, Rn: a spectral reflectance of a color patch whose index number is m, n; N: the number of color patches in the color chart; Σ: a sum of all combinations of m and n)

### BACKGROUND

### Field

The present disclosure generally relates to image processing and, more particularly, to an image processing apparatus, a control method, a non-transitory computer-readable storage medium storing a computer program, and a color chart.

### Description of the Related Art

In recent years, various cameras have been released by respective camera manufacturers, but respective manufacturers' hardware specifications and development processes are not unified, and so, even if captured images are of the same subject, the captured images will not have the same red, green, blue (RGB) signals. For example, RGB signals obtained by imaging with a camera depend on the optical system (e.g., imaging lenses), the gamma function of the camera, the spectral transmittances of color filters, the spectral sensitivity characteristics of the sensor, the arrangement of the filters, white balance, and the like. Therefore, the RGB signals obtained by imaging will be different even if the same subject is imaged.

Accordingly, in recent years, techniques in which RGB signals are corrected such that the same subject can be outputted with the same RGB signals even when captured by different models of cameras has been proposed (e.g., Japanese Patent No. 4136820 and Japanese Patent No. 5097927). These correction techniques are realized by imaging a color chart (e.g., a Macbeth chart) for color proofing and generating a three-dimensional look-up table (3D LUT) in which values of pixels imaged by the respective cameras are associated with each other.

When generating a 3D LUT using the above-described technique to align the colors of different models of cameras, it is necessary to image a color chart under the same lighting environment as in an actual shooting location. Japanese Patent No. 4182023 proposes a technique in which, by inferring the spectral characteristics of a camera from an image in which a color chart has been imaged in advance in another environment, a 3D LUT is generated without imaging the color chart at a shooting location.

However, in the technique disclosed in Japanese Patent No. 4182023, the accuracy of prediction of the spectral characteristics of a camera varies greatly depending on the color chart to be imaged. It is difficult to accurately infer the spectral characteristics of a camera using a commercial color chart.

### SUMMARY

Therefore, according to some embodiments, a color chart for inferring the spectral characteristics of a camera with high accuracy can be generated.

According to some embodiments, an image processing apparatus can include an obtaining unit configured to obtain spectral reflectances of a plurality of color patches, and a control unit configured to generate design data of a color chart including a plurality of color patches selected so as to reduce an evaluation value E of the color chart calculated based on Equation (I) from the spectral reflectances of the plurality of color patches.

$$\begin{matrix}[ EQUATION I ] & \\ E = \frac{\sum ( \frac{{R}_{m} \cdot {R}_{n}}{\vert {R}_{m} \vert \vert {R}_{n} \vert} )}{{N}^{{C}_{2}}} & ( I )\end{matrix}$$

(Rm, Rn: a spectral reflectance of a color patch whose index number is m, n; N: the number of color patches in the color chart; Σ: a sum of all combinations of m and n)

According to some embodiments, a method of controlling an image processing apparatus can include obtaining spectral reflectances of a plurality of color patches, and generating design data of a color chart including a plurality of color patches selected so as to reduce an evaluation value E of the color chart calculated based on Equation (I) from the spectral reflectances of the plurality of color patches.

$$\begin{matrix}[ EQUATION I ] & \\ E = \frac{\sum ( \frac{{R}_{m} \cdot {R}_{n}}{\vert {R}_{m} \vert \vert {R}_{n} \vert} )}{{N}^{{C}_{2}}} & ( I )\end{matrix}$$

(Rm, Rn: a spectral reflectance of a color patch whose index number is m, n; N: the number of color patches in the color chart; Σ: a sum of all combinations of m and n)

According to some embodiments, a non-transitory computer-readable storage medium storing a computer program to be read and executed by a computer to can cause the computer to obtain spectral reflectances of a plurality of color patches, and generate design data of a color chart including a plurality of color patches selected so as to reduce an evaluation value E of the color chart calculated based on Equation (I) from the spectral reflectances of the plurality of color patches.
(Rm, Rn: a spectral reflectance of a color patch whose index number is m, n; N: the number of color patches in the color chart; E: a sum of all combinations of m and n)

$$E = \frac{\sum ( \frac{{R}_{m} \cdot {R}_{n}}{\vert {R}_{m} \vert \vert {R}_{n} \vert} )}{{N}^{{C}_{2}}} \qquad [ EQUATION I ]$$

According to some embodiments, a color chart can include a plurality of color patches and whose evaluation value E calculated based on Equation (I) from spectral reflectances of the plurality of color patches is less than or equal to 0.7.

$$\begin{matrix}[ EQUATION I ] & \\ E = \frac{\sum ( \frac{{R}_{m} \cdot {R}_{n}}{\vert {R}_{m} \vert \vert {R}_{n} \vert} )}{{N}^{{C}_{2}}} & ( I )\end{matrix}$$

(Rm, Rn: a spectral reflectance of a color patch whose index number is m, n; N: the number of color patches in the color chart; Σ: a sum of all combinations of m and n)

Further features of the present disclosure will become apparent from the following description of exemplary embodiments (with reference to the attached drawings).

### BRIEF DESCRIPTION OF THE DRAWINGS

FIG. 1 is a functional block diagram of a system including an image processing apparatus according to a first embodiment.

FIG. 2 is an example of a hardware configuration for realizing the image processing apparatus according to the first embodiment.

FIG. 3 is a flowchart for explaining a flow of processing of the image processing apparatus according to the first embodiment.

FIG. 4 is a flowchart for explaining chart evaluation value calculation processing of step S502 in detail.

FIG. 5 is a diagram illustrating a configuration of the system according to a second embodiment.

FIG. 6 is a flowchart for explaining design data generation processing of step S204 in detail.

FIG. 7 is a diagram illustrating an overall appearance of a generated color chart.

FIG. 8 is a diagram illustrating an example of spectral characteristics of color patch materials constituting a generated color chart.

FIG. 9 is a flowchart for explaining an overview of the operation of the image processing apparatus according to a third embodiment.

FIG. 10 is a diagram illustrating a UI for setting conditions of a color chart to be generated by the image processing apparatus according to the third embodiment.

FIG. 11 is a diagram illustrating a relationship between vertical and horizontal directions and XY coordinates of color patch materials according to the third embodiment.

FIG. 12 is a diagram illustrating an error display according to the third embodiment.

FIG. 13 is a diagram illustrating list of color patch materials after addition of color patch materials according to the third embodiment.

FIG. 14 is a table illustrating an example for when a color chart according to an embodiment and commercial color charts are evaluated using an evaluation value E.

FIG. 15 is a table illustrating peak spectral wavelengths of color patch materials obtained in a color chart, which has been generated in the inventors' experimentation and for which the present invention has been used.

### DESCRIPTION OF THE EMBODIMENTS

Hereinafter, various exemplary embodiments, features, and aspects will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

Further, each step of a flowchart will be indicated using a reference numeral starting with S.

### First Embodiment

First, a first embodiment will be described. In the present embodiment, color samples (hereinafter color patch materials or color patches), for which coloring agents to be candidates for constituting a color chart are used, are inputted to an image processing apparatus to be disclosed in the present embodiment. The image processing apparatus measures the spectra of the inputted color patch materials. The image processing apparatus holds pieces of spectral measurement data, which are the measurement results, with the names of the inputted color patch materials. Then, the image processing apparatus evaluates, based on the held pieces of spectral measurement data, an optimal combination of color patch materials for generating a color chart for inferring the spectrum characteristics of a camera (hereinafter, color chart) and outputs the evaluation result as design data. Lastly, the image processing apparatus generates a color chart based on the outputted design data by referencing the material names and allocating the color chart materials. The present embodiment will be described in detail below with reference to the drawings. The description will be given assuming that the present embodiment generates a color chart that has 36 color patch materials.

### (Overall Configuration)

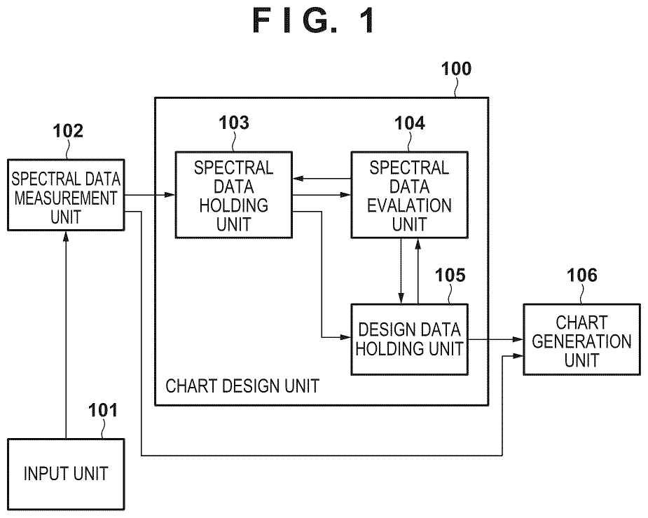

FIG. 1 is a functional block diagram of a system including an image processing apparatus according to the first embodiment.

An image processing apparatus 100 performs a main function of the present embodiment and generates design data based on pieces of spectral measurement data of color patch materials.

The color patch materials, which are materials for generating a color chart to be disclosed in the present embodiment, are inputted into an input unit 101. In the present embodiment, for example, color samples that have been cut into 2-cm squares and coated with a coloring agent or on which a coloring agent has been printed are assumed as the color patch materials, and these are stacked vertically and placed at a predetermined position in the input unit 101 of the system. The input unit 101 takes out the vertically stacked color patch materials in order from the top by vacuum suction or the like and sends them to a spectral data measurement unit 102. The input unit 101 assigns index numbers, together with color patch material names, to the inputted color patch materials in the order in which they have been taken out. The input unit 101 sends the index numbers to the spectral data measurement unit 102.

The spectral data measurement unit 102 measures the spectral reflectances of the color patch materials sent from the input unit 101. In the present embodiment, the spectral data measurement unit 102 includes, for example, a spectrometer and a setting table and sets a color patch material sent from the input unit 101 on the setting table. Then, the spectral data measurement unit 102 measures the spectral reflectance of the color patch material set on the setting table, using the spectrometer. The spectral data measurement unit 102 sends patch data for which the spectral measurement data, which is the measured spectral reflectance data, has been associated with an index number sent from the input unit 101 to a spectral data holding unit 103. Further, the spectral data measurement unit 102 holds measured color patch materials. For example, the spectral data measurement unit 102 holds the measured color patch materials by stacking them together vertically.

The spectral data holding unit 103 holds patch data generated by the spectral data measurement unit 102. Further, the spectral data holding unit 103 passes spectral measurement data together with the index number to a spectral data evaluation unit 104 in response to a request from the spectral data evaluation unit 104.

The spectral data evaluation unit 104 fetches one piece of candidate spectral measurement data from the pieces of spectral measurement data within the pieces of patch data held in the spectral data holding unit 103. Then, the spectral data evaluation unit 104 refers to pieces of spectral measurement data constituting the tentative design data of a color chart held in a design data holding unit 105 and evaluates whether the spectral measurement data is suitable for the color chart. Tentative design data is data of a color chart in which the number of color patch materials (number of color patches) has not reached a predetermined target number of patches in the chart for design data and can be said to be tentative design data in the process of generating design data. The evaluation processing will be described later in detail. The spectral data evaluation unit 104 sends the spectral measurement data of a color patch material to the design data holding unit 105 if it determines that the spectral measurement data is that of a color patch material suitable for the color chart as a result of the evaluation.

The design data holding unit 105 obtains and holds, as the design data or tentative design data of a color chart, pieces of spectral measurement data evaluated by the spectral data evaluation unit 104 as the pieces of spectral measurement data of color patch materials suitable for the color chart. At this time, the design data holding unit 105 obtains the color patch material names associated with the pieces of spectral measurement data from the spectral data holding unit 103 based on the index numbers of the pieces of spectral measurement data.

A chart generation unit 106 obtains color patch materials held in the spectral data measurement unit 102 based on the design data of a color chart held in the design data holding unit 105 and generates and outputs the color chart. In the present embodiment, for example, the chart generation unit 106 generates a color chart using a machine tool 1014, which will be described later. The chart generation unit 106 references the index numbers of the color patch materials based on the design data and fetches color patch materials corresponding to the index numbers from the spectral data measurement unit 102. Then, the chart generation unit 106 adheres the color patch materials onto the backing paper of the color chart. The chart generation unit 106 generates the color chart by performing this operation for the number of color patch materials.

### (Hardware Configuration for Realizing Present Embodiment)

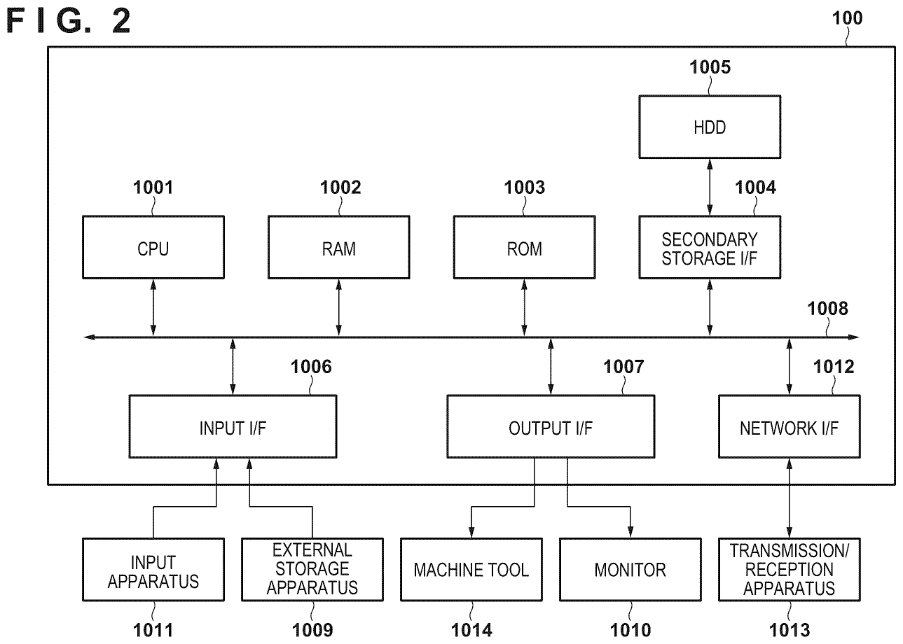

FIG. 2 is an example of a hardware configuration for realizing the image processing apparatus 100.

The image processing apparatus 100 includes a CPU 1001, a RAM 1002, a ROM 1003, a secondary storage interface (I/F) 1004, an HDD 1005, an input interface (I/F) 1006, an output interface (I/F) 1007, and a network interface (I/F) 1012. The respective components of the image processing apparatus 100 are connected to each other by a system bus 1008. The image processing apparatus 100 is connected to an external storage apparatus 1009 and an input apparatus 1011 via the input I/F 1006. Further, the image processing apparatus 100 is connected to the machine tool 1014 and a monitor 1010 via the output I/F 1007. The image processing apparatus 100 is connected to a transmission/reception apparatus 1013 via the network I/F 1012.

The central processing unit (CPU) 1001 may be a processor, circuitry, or combinations thereof and is an example of a control unit. The CPU 1001 comprehensively controls the respective components of the image processing apparatus 100 via the system bus 1008 by executing a program stored in the ROM 1003 or the HDD 1005 using the RAM 1002 as a working memory. The random access memory (RAM) 1002 is an example of a volatile storage apparatus. The RAM 1002 includes an area for storing computer programs and data loaded from the ROM 1003 or the HDD 1005. The RAM 1002 also includes an area for storing data received from the transmission/reception apparatus 1013 via the network I/F 1012. The read only memory (ROM) 1003 stores setting data of the image processing apparatus 100, computer programs and data related to activation of the image processing apparatus 100, computer programs and data related to basic operations of the image processing apparatus 100, and the like. The hard disk drive (HDD) 1005 stores an operating system (OS), computer programs and data for causing the CPU 1001 to execute or control various kinds of processing which will be described as processing to be performed by the image processing apparatus 100, and the like. For example, the CPU 1001 realizes the functions of the spectral data holding unit 103, the spectral data evaluation unit 104, and the design data holding unit 105 by loading a program stored in the ROM 1003 or the HDD 1005 into the RAM 1002. In addition to the CPU 1001 and the RAM 1002, a graphics processing unit (GPU) and a video random access memory (VRAM) may be provided. The HDD 1005 stores various kinds of data and programs to be handled by the image processing apparatus 100. The CPU 1001 writes data to the HDD 1005 and reads data and programs stored in the HDD 1005 via the system bus 1008. In addition to or instead of the HDD 1005, a non-volatile storage apparatus, such as an optical disk drive or a flash memory, may be used.

The input I/F 1006 is, for example, a serial bus interface, such as a USB or IEEE 1394. The image processing apparatus 100 receives input of data, commands, and the like from an external apparatus via the input I/F 1006. In the present embodiment, the image processing apparatus 100 obtains data from the external storage apparatus 1009 (e.g., storage medium, such as a hard disk, a memory card, a CF card, an SD card, or a USB memory) via the input I/F 1006. In the present embodiment, the image processing apparatus 100 obtains user instructions inputted to the input apparatus 1011 via the input I/F 1006. The input apparatus 1011 is an input apparatus, such as a mouse or a keyboard, and receives input of user instructions. In addition, data from when the spectral data measurement unit 102 measured the spectrum of a spectral color patch material is inputted to the image processing apparatus 100 via the input I/F 1006.

The output I/F 1007 is a serial bus interface, such as a USB or IEEE 1394 interface, as in the input I/F 1006. The output I/F 1007 may be, for example, a video output terminal, such as a DVI or an HDMI® interface. In the present embodiment, the image processing apparatus 100 outputs data processed by the CPU 1001 to the monitor 1010 (various kinds of image display device, such as a liquid crystal display) via the output I/F 1007. Further, a spectrometer for when passing a color patch material from the input unit 101 to the spectral data measurement unit 102 and measuring a spectrum of the color patch material and the machine tool 1014 used when generating a color chart based on design data are controlled via the output I/F 1007.

The network I/F 1012 is, for example, a connector for connecting to a network, such as Ethernet®, via the transmission/reception apparatus 1013 and receives information sent from an external apparatus and stores the information in the RAM 1002 or the like in the image processing apparatus 100 via the system bus 1008.

Although there are components of the image processing apparatus 100 in addition to those described above, they are not the main focus of the present embodiment, and so, description thereof will be omitted. The image processing apparatus 100 can be constituted by an apparatus, such as a personal computer, a workstation, or another imaging device, for example. At this time, the respective processes to be performed by the spectral data holding unit 103, the spectral data evaluation unit 104, and the design data holding unit 105 of the image processing apparatus 100 are realized as functions of a program to be executed in the image processing apparatus 100.

In the present embodiment, the image processing apparatus 100 having a configuration such as the one described above obtains spectral measurement data by measuring a color patch material using a spectrometer or the like connected to the output I/F 1007 based on a command from the CPU 1001. In addition, the image processing apparatus 100 designs and generates a color chart based on pieces of spectral measurement data, using the machine tool 1014 or the like connected to the output I/F 1007.

### (Processing Flow of Entire Image Processing Apparatus)

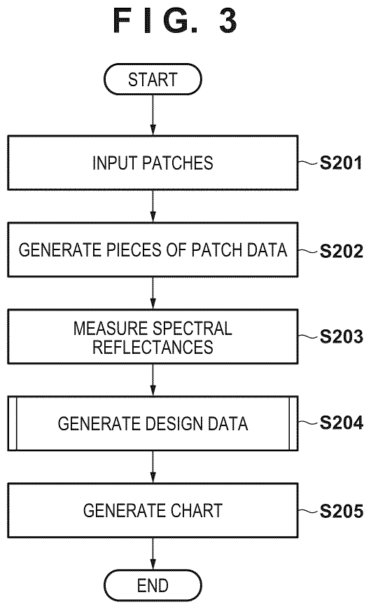

Next, a flow of processing of the system according to the present embodiment will be described. FIG. 3 is a flowchart for explaining a flow of processing of the image processing apparatus 100 according to the first embodiment.

In step S201, as described above, the input unit 101 sequentially fetches the vertically stacked color patch materials from the top by vacuum suction or the like and sends them to the spectral data measurement unit 102 and assigns index numbers to the inputted color patch materials and sends those index numbers to the spectral data measurement unit 102.

In step S202, the spectral data measurement unit 102 generates pieces of patch data based on the sent color patch materials. A piece of patch data includes the index number and the color patch material name of a color patch material and spectral measurement data indicating the spectral reflectance of that color patch material. The spectral measurement data of a color patch material is yet to have a value at this point, and the value is stored in step S203. In addition, the spectral data measurement unit 102 initializes design data. The initialized design data may be, for example, null data that does not include color patch material data or the like.

In step S203, the spectral data measurement unit 102 measures the spectral reflectance of a color patch material and stores the spectral measurement data obtained by the measurement in patch data. The patch data in which the spectral measurement data is stored together with the index number and the color patch material name is sent to the spectral data holding unit 103. The spectral data holding unit 103 holds the received patch data.

In step S204, the spectral data evaluation unit 104 evaluates the spectral measurement data of patch data held in the spectral data holding unit 103 and sends the spectral measurement data and the index number to the design data holding unit 105 when it determines that the spectral measurement data is suitable for a color chart. The design data holding unit 105 generates design data for which color patch material names obtained from the spectral data holding unit 103 based on the index numbers and pieces of spectral measurement data received from the spectral data evaluation unit 104 have been combined and stores the design data.

Design data is data that is to be a design plan of a color chart to be generated and stores the number of patches and the patch size of the color chart, data on the arrangement of the color chart materials in the chart, and the patch data of each color patch material. At the start of the operation of the processing, null data is stored as an initial parameter. When the processing of step S204 is completed, actual data is stored in the design data.

In step S205, the chart generation unit 106 generates a color chart based on the design data of a color chart held in the design data holding unit 105. The color patch materials held in the spectral data measurement unit 102 are employed as the color patch materials to be used to generate the color chart at this time. The color chart will be described later in detail.

### <Details of Design Data Generation Processing of Step S204>

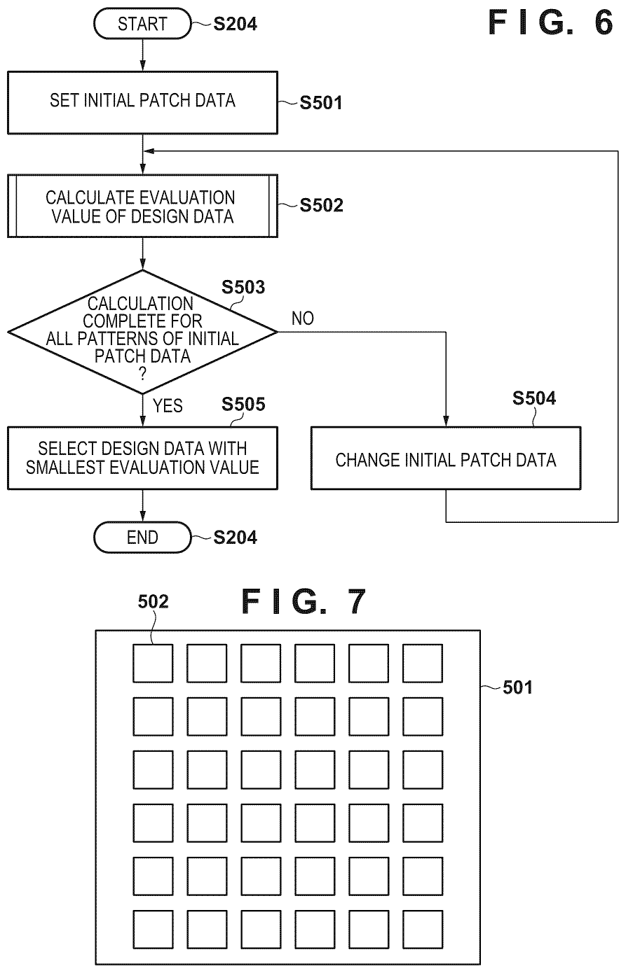

The design data generation processing of step S204 will be described in detail with reference to the flowchart of FIG. 6. In the processing, first, the spectral data evaluation unit 104 sets, as initial patch data, one piece of patch data selected from all pieces of patch data, which are inputted color chart candidates. Then, the spectral data evaluation unit 104 generates the tentative design data of a color chart based on the initial patch data. In other words, the spectral data evaluation unit 104 generates tentative design data that includes only one piece of color patch material data.

Further, the spectral data evaluation unit 104 adds patch data that is different from the initial patch data selected from all pieces of patch data and updates the tentative design data. The spectral data evaluation unit 104 calculates an evaluation value of the generated tentative design data and sets the tentative design data to which the color patch material has been added as new tentative design data if it is evaluated that the added color patch material is suitable for the color chart and discards the color patch material from the tentative design data and does not update the tentative design data if it is determined that the added color patch material is not suitable for the color chart. The spectral data evaluation unit 104 repeats this and sends the tentative design data to the design data holding unit 105 as design data when the number of color patch materials included in the tentative design data reaches the target number of patches in the chart. The design data holding unit 105 holds the design data. Details will be described below.

In step S501, the spectral data evaluation unit 104 selects and sets initial patch data of tentative design data for which an evaluation value E is to be calculated.

In step S502, the spectral data evaluation unit 104 generates tentative design data based on the initial patch data set in step S501 and calculates the evaluation value E. Details will be described later.

In step S503, the spectral data evaluation unit 104 determines whether all possible patterns of tentative design data for initial patch data have been generated and the color chart evaluation values E calculated. The spectral data evaluation unit 104 transitions to step S505 if the evaluation values E have been calculated for the tentative design data of all pieces of initial patch data and transitions to step S504 otherwise. By this, the spectral data evaluation unit 104 generates tentative design data that includes the target number of patches of color patch materials in the chart for a plurality of pieces of initial patch data. Accordingly, when the processing proceeds to step S505, a plurality of pieces of tentative design data, each including the target number of patches of color patch materials in the chart, are generated.

In step S504, the spectral data evaluation unit 104 changes the set initial patch data and obtains, from the spectral data holding unit 103, patch data to which the change has been made. The spectral data evaluation unit 104 changes the initial patch data to, for example, the patch data of a color patch material for which tentative design data has not yet been generated.

In step S505, the spectral data evaluation unit 104 selects the tentative design data of a color chart that has the smallest evaluation value E among the plurality of pieces of tentative design data, each including the target number of patches of color patch materials in the chart, and outputs the selected tentative design data as design data to the design data holding unit 105.

### <Details of Color Chart Evaluation Value Calculation Processing of Step S502>

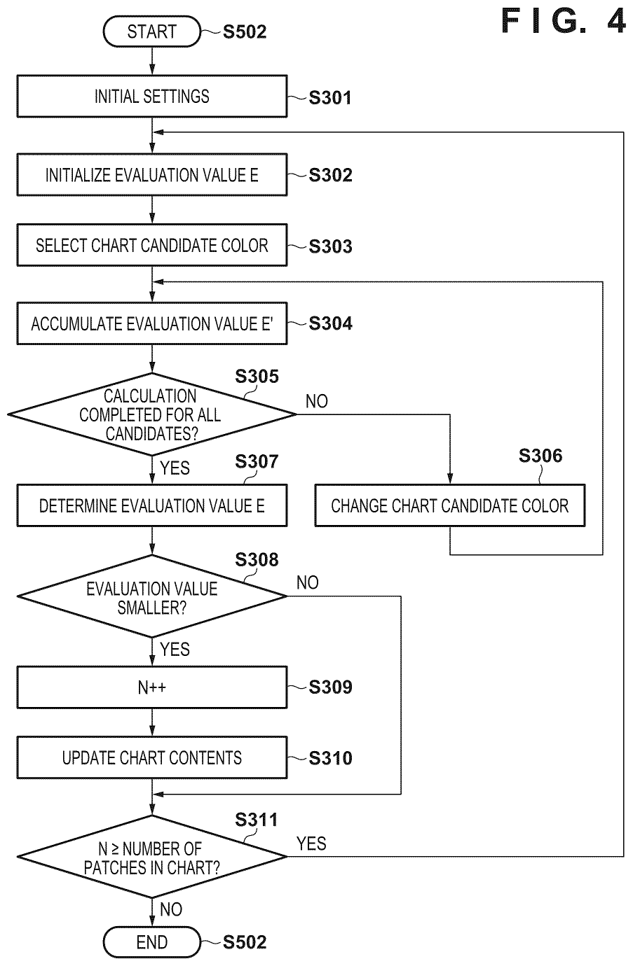

The processing for calculating the evaluation value E of a color chart in step S502 will be described in detail with reference to the flowchart of FIG. 4.

In step S301, the spectral data evaluation unit 104 performs an initialization operation prior to the evaluation. Specifically, the current total number N of selections for tentative design data is set to 1. Further, the spectral data evaluation unit 104 incorporates the initial patch data selected in advance into the tentative design data and holds the tentative design data in the design data holding unit 105.

In step S302, the spectral data evaluation unit 104 initializes the evaluation value E and sets E=1.0. The evaluation value E will be described later.

In step S303, the spectral data evaluation unit 104 obtains one piece of patch data from the plurality of pieces of patch data held in the spectral data holding unit 103. At this time, the spectral data evaluation unit 104 selects and obtains the initial patch data and patch data other than previously-selected patch data.

In step S304, the spectral data evaluation unit 104 extracts spectral measurement data from each of the obtained patch data. Then, the spectral data evaluation unit 104 calculates an evaluation value E′ between the color patch materials by calculating Equation (1) indicated below.

$$\begin{matrix}[ EQUATION 1 ] & \\ {E}^{′} = \frac{{R}_{m} \cdot {R}_{n}}{\vert {R}_{m} \vert \vert {R}_{n} \vert} & ( 1 )\end{matrix}$$

Here, R is spectral measurement data, which is the spectral reflectance of a respective color patch material, and m and n are each any one of the index number of patch data incorporated into the tentative design data of the design data holding unit 105 and the index number of the patch data obtained in step S303. That is, Rm and Rn are each any one of spectral measurement data included in patch data incorporated in the tentative design data of the design data holding unit 105 and spectral measurement data included in the patch data obtained in step S303. The spectral measurement data Rm and Rn, which are spectral reflectances, are three-dimensional vectors each of whose elements in an RGB or Lab color space, for example, is a positive value. Therefore, based on a definition of inner product, the evaluation value E′ is cos 0 when an angle between a vector Rm and a vector Rn is θ. A smaller evaluation value E′ indicates that the angle θ between the vector Rm and the vector Rn is closer to 90° and indicates that the directions of both vectors are significantly different. When spectral reflectance data at the time of measurement is RGB color space vector data, the spectral measurement data R may be converted into Lab color space vector data. For example, when the number of color patch materials included in the tentative design data is two, the index number of the initial patch data is 1, and the index number of the patch data of the tentative design data that has been set is 2, m=1 and n=2.

In step S305, the spectral data evaluation unit 104 determines whether the calculation of step S304 has been performed for all patch data candidates. The spectral data evaluation unit 104 transitions to step S307 if the calculation has been performed and transitions to step S306 if the calculation has not performed.

In step S306, the spectral data evaluation unit 104 changes a color chart candidate color by changing the index number of patch data of the tentative design data that corresponds to n for when calculating the evaluation value E′ to be calculated in step S304.

In step S307, the spectral data evaluation unit 104 divides the sum of the evaluation values E′ of all combinations of m and n calculated in steps S303 to S306 by the total number of combinations _{N}C₂ and determines it as an evaluation value E. Specifically, the following Equation (2) is assumed. Therefore, it can be said that the evaluation value E is an arithmetic mean of the evaluation values E′. As described above, a small evaluation value E′ means that the directions of the vector Rm and the vector Rn are significantly different from each other, and so, a small evaluation value E means that there is variation in the directions of all vectors R included in the color chart. That is, a small evaluation value E means that the colors of the color patch materials of the color chart are not similar to each other.

$$\begin{matrix}[ EQUATION 2 ] & \\ E = \frac{\sum ( \frac{{R}_{m} \cdot {R}_{n}}{\vert {R}_{m} \vert \vert {R}_{n} \vert} )}{{N}^{{C}_{2}}} & ( 2 )\end{matrix}$$

Here, the numerator portion of Equation (2) is the sum of the evaluation values E′ of all combinations of m and n calculated in steps S303 to S306. N is the current number of color chart color patch materials in the tentative design data, and when two color patch materials have been selected to be in the current tentative design data, N is 3 including the color patch material of the initial patch data. When the design data of the color chart is finally completed, N is 36, which is the target number of patches in the chart.

In step S308, the spectral data evaluation unit 104 determines whether to update the tentative design data based on the evaluation value E. Specifically, the spectral data evaluation unit 104 compares the evaluation value E newly calculated in step S307 with a currently-held evaluation value E. Here, the currently-held evaluation value E is the evaluation value E of tentative design data (example of first tentative design data) before the newly-added color patch material was added. The newly-calculated evaluation value E is the evaluation value E of tentative design data (example of second tentative design data) that includes the newly-added color patch material. The spectral data evaluation unit 104 transitions to step S309 if the evaluation value E calculated in step S307 is smaller than the currently-held evaluation value E and transitions to step S311 otherwise. In other words, if the evaluation value E is not reduced by the newly-added color patch material, the spectral data evaluation unit 104 discards the added color patch material and does not update the tentative design data. Accordingly, the spectral data evaluation unit 104 updates the tentative design data such that the evaluation value E is reduced each time a color patch material is added.

In step S309, the spectral data evaluation unit 104 increments N by 1 and transitions to step S310.

In step S310, the spectral data evaluation unit 104 changes the currently-held evaluation value E to the evaluation value E determined in step S307. In addition, the spectral data evaluation unit 104 updates the tentative design data of the color chart that corresponds to the determined evaluation value E. Accordingly, the spectral data evaluation unit 104 adds a color patch material to the tentative design data when the evaluation value E is reduced, and so, the evaluation value E of the tentative design data is reduced with addition of a color patch material.

In step S311, the spectral data evaluation unit 104 determines whether N is less than the target number of patches (36 in the present embodiment) in the chart determined in advance. If N is less than the target number of patches in the chart, the processing transitions to step S302, and otherwise, the processing ends.

### (Details of Color Chart to be Generated)

Next, a camera spectral characteristic color chart to be generated by the image processing apparatus described in the present embodiment will be described in detail.

Assuming that the spectral characteristics of a camera are defined such that 380 nanometers (nm) to 730 nm, which are visible wavelengths, are divided into 10 nm increments, there may be at least 36 color patch materials in the color chart in order to infer the spectral characteristics of the camera. In addition, in order to reduce the above-described evaluation value E, it is assumed to reduce the spectral relevance between color patch materials (i.e., increase spectral orthogonality). Further, there is a high possibility that a plurality of respective patches having peaks in spectral wavelength bands, 440 nm to 470 nm, 500 nm to 540 nm, and greater than or equal to 600 nm, which are respective spectral sensitivity characteristics of R, G, and B of a typical camera, are selected as the color patch materials.

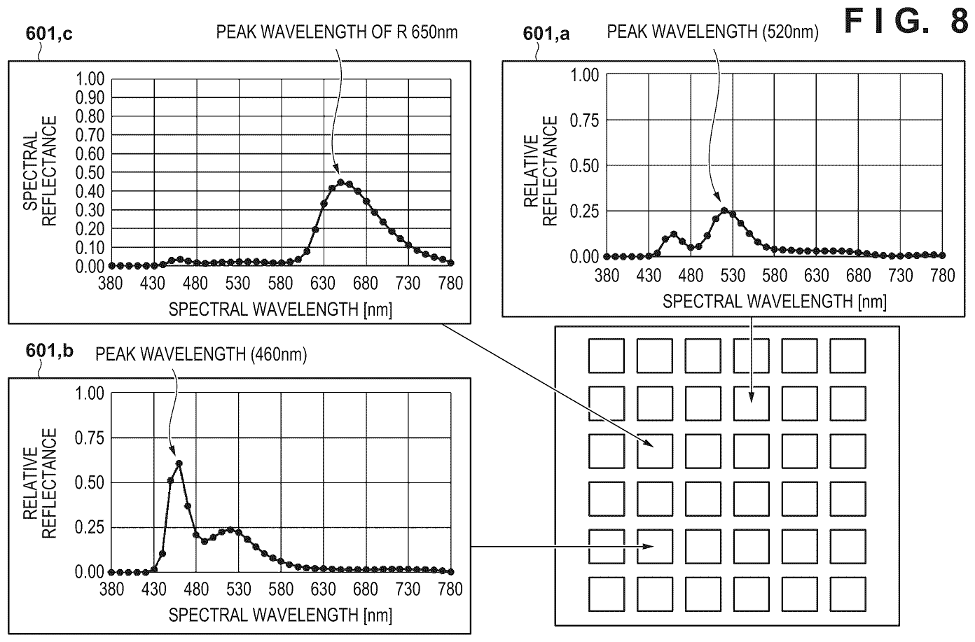

FIG. 7 is a diagram illustrating an overall appearance of a color chart generated in the inventors' experimentation. FIG. 8 is a diagram illustrating an example of spectral characteristics of color patch materials constituting the generated color chart. FIG. 15 is a table illustrating peak spectral wavelengths of color patch materials obtained in the color chart, which was generated based on the present disclosure. The evaluation value E of the generated color chart was 0.527.

A chart base 501 is, for example, a gray base.

Regarding color patch materials 502, color patch materials adopted from among an inputted group of color patch materials, are adhered to the present color chart. A spectral reflectance is defined for each color patch material 502. As illustrated in FIG. 8, the spectral reflectance of a certain color patch material 502 has a peak wavelength at 520 nm as indicated in a graph 601 (a). A color patch material indicated in another graph 601 (b) has a peak wavelength at 460 nm. Further, a red (R) color patch material indicated in a graph 601 (c) has a peak wavelength at 650 nm.

Further, as illustrated in FIG. 15, the color chart to be generated in the present embodiment includes a plurality of color patch materials 502 having reflectance peaks (=peak spectral wavelength bands) in spectral wavelengths greater than or equal to 600 nm. Similarly, the color chart includes a plurality of color patch material 502 having a reflectance peak in spectral wavelengths from 500 nm to 540 nm, and a plurality of color patch materials 502 having reflectance peaks in spectral wavelengths from 440 nm to 470 nm.

A color chart in which the waveform of the spectral reflectance of each patch tends to have a clearer peak than that of a typical color patch material and for which the spectral reflectance outside the peak tends to be low as illustrated in FIGS. 8 and 15 is more likely to be selected. In contrast, when generating a color chart that includes various hues using typical reflective color materials, not only color patch materials whose spectral reflectance has a peak as described above but also color patch materials whose spectral reflectance characteristic does not have a clear peak or has a shape similar to that of a sigmoid function are included. In such a typical color chart, the orthogonality between color patch materials is low, and so, the evaluation value E of the color chart tends to increase. According to the inventors' experimentation, it has been found that an error in inferring the characteristics of a camera increases when the evaluation value E of the color chart is greater than or equal to a specific value. The specific value is, for example, 0.7.

FIG. 14 is a table illustrating an example for when a color chart of a working example according to the present embodiment and commercial color charts of comparative examples are evaluated using the evaluation values E. The result of a comparative example 1 of FIG. 14 is 0.816, and the result of a comparative example 2 is 0.862. From these results, it can be seen that the evaluation value E does not fall below 0.7 simply by using a commercial color chart as is. In contrast, when the color chart proposed in the present embodiment is evaluated using the evaluation value E, the evaluation value E falls below 0.7. From this, it can be seen that the color chart of the working example proposed in the present embodiment has a different tendency from a typical color chart. The color chart of the working example generated in the present proposal cannot be realized by simply using a commercial product color chart as is, and it is necessary to select, from color patch materials constituting the commercial product color chart, color patch materials having different spectral characteristics and combine them. By selecting and combining color patch materials as such, it is possible to make the evaluation value E less than or equal to 0.7.

As described above, according to the present embodiment, the design data of a color chart including a plurality of color patch materials is generated, using the color patch materials selected so as to reduce the evaluation value E, based on the evaluation value E calculated from the spectral reflectances of the color patch materials. Accordingly, in the present embodiment, it is possible to generate a color chart in which color patch materials are varied in a color space, whose evaluation value E is small (e.g., evaluation value E is less than or equal to 0.7), and with which the spectral characteristics of a camera can be inferred with high accuracy. As a result, in the present embodiment, it is possible to obtain a color chart with which the spectral characteristic data of a camera can be inferred with high accuracy, which is necessary for when generating a 3D LUT supporting various subjects for aligning colors between different cameras without imaging the color chart at a shooting location.

In the present embodiment, tentative design data is generated by adding one color patch material to already-generated tentative design data, and when the evaluation value E is smaller than the evaluation value E before the color patch material was added, update is performed with the tentative design data to which the color patch material has been added as new tentative design data. Accordingly, in the present embodiment, it is possible to reduce the amount of calculation compared to when the evaluation values E are compared after design data of the target number of patches in the chart has been generated, and it is possible to efficiently generate the design data of a color chart.

In the present embodiment, design data is generated by adding color patch materials while reducing the evaluation value E and updating tentative design data, until the target number of patches in the chart is reached. Accordingly, in the present embodiment, it is possible to efficiently generate design data with a desired number of patches in the chart and whose evaluation value E is small.

In the present embodiment, a plurality of pieces of tentative design data with the target number of patches in the chart are generated as the initial patch data is changed, and the tentative design data with the smallest evaluation value E is used as the design data of a color chart. Accordingly, in the present embodiment, it is possible to generate design data with a smaller evaluation value E.

In the present embodiment, an example in which a color chart is generated by a machine tool has been described; however, not only a generation method in which a machine tool adheres color patch materials but also a generation method in which a printer or the like performs printing is conceivable.

In the present embodiment, an example in which a color chart is generated using reflective materials has been described; however, the color patch materials are not limited to reflective materials, and light-emitting materials (e.g., LEDs) may be used. At this time, for measurement of the spectra of the materials, a dedicated apparatus for causing LEDs to emit light and for performing measurement is useful. In addition, when outputting a color chart based on design data, a dedicated machine tool that wires LEDs, assembles a circuit for supplying power, and the like is useful.

### Second Embodiment

In the first embodiment, color patch materials to be candidates for constituting a color chart for predicting the spectral characteristics of a camera are inputted to the image processing apparatus, spectrum thereof are measured, and design data is generated from the obtained spectral measurement data. In the present embodiment, the flow of processing is the same, but the calculation of the evaluation value E, which is calculated at the time of generating design data, is performed on the cloud. Details thereof will be described below. In the present embodiment, only portions different from the first embodiment will be described.

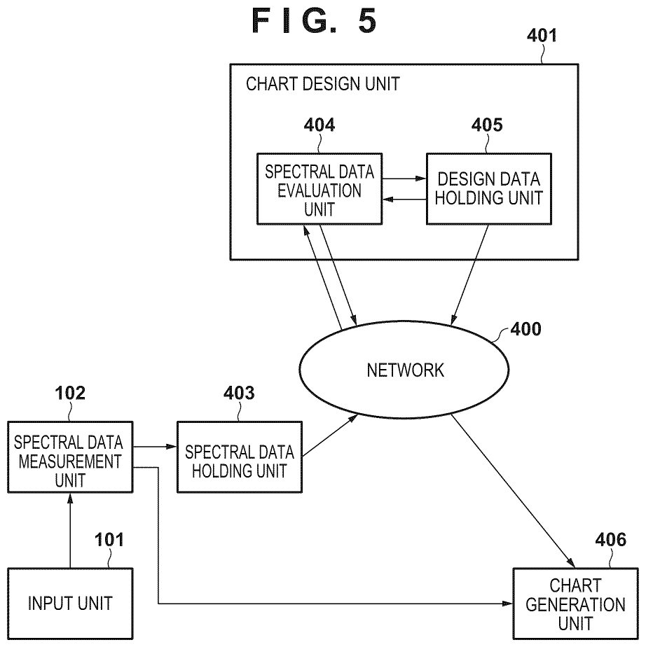

FIG. 5 is a diagram illustrating a configuration of the system according to a second embodiment.

A network 400 refers to a typical network, such as the Internet.

A design data generation unit 401 includes a spectral data evaluation unit 404 and a design data holding unit 405 as main functions. The design data generation unit 401 performs input necessary for calculation and output of a calculation result, using the network 400.

Regarding a spectral data holding unit 403, the main functions are the same as those of the spectral data holding unit 103. A point of difference from the spectral data holding unit 103 is that it inputs the spectral measurement data of held patch data to the spectral data evaluation unit 404 via the network 400.

Regarding the spectral data evaluation unit 404, the main functions are the same as those of the spectral data evaluation unit 104. A point of difference from the spectral data evaluation unit 104 is that it obtains the spectral measurement data of patch data via the network 400.

Regarding the design data holding unit 405, the main functions are the same as those of the design data holding unit 105. A point of difference from the design data holding unit 105 is that the design data holding unit 405 sends generated design data to a chart generation unit 406 via the network 400.

The chart generation unit 406 takes input of design data via the network 400. Color patch materials are inputted from the spectral data measurement unit 102. Based on these pieces of input data, a color chart for inferring the spectral characteristics of a camera is generated.

As described above, according to the present embodiment, it is possible to obtain a color chart with which camera spectral characteristic data necessary for when generating a 3D LUT for aligning colors between cameras can be predicted more accurately without imaging the color chart at a shooting location.

### Third Embodiment

In the first embodiment and the second embodiment, an example in which a color chart having 36 color patch materials is generated based on inputted color patch materials has been described. In the present embodiment, a case where a UI for designating the total number and the color patch size of color patch materials to be incorporated in the color chart and the size of the color chart itself is provided will be described. In the present embodiment, only portions different from the first embodiment and the second embodiment will be described, similarly to the second embodiment.

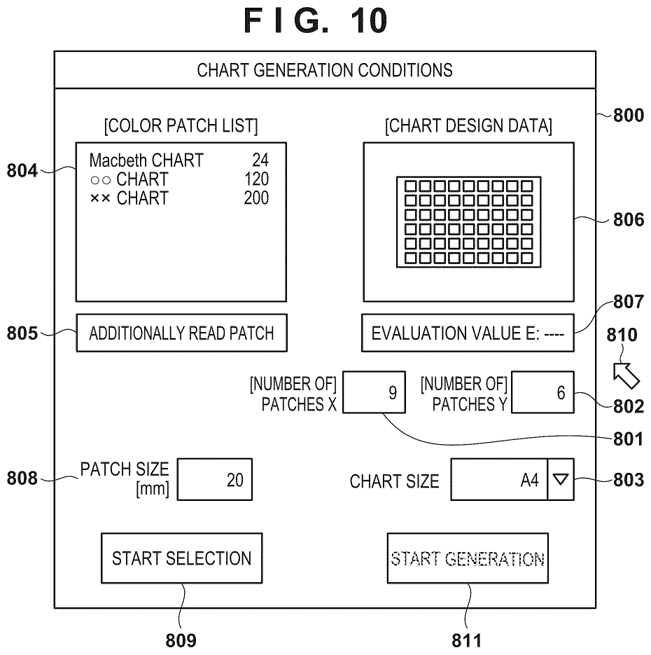

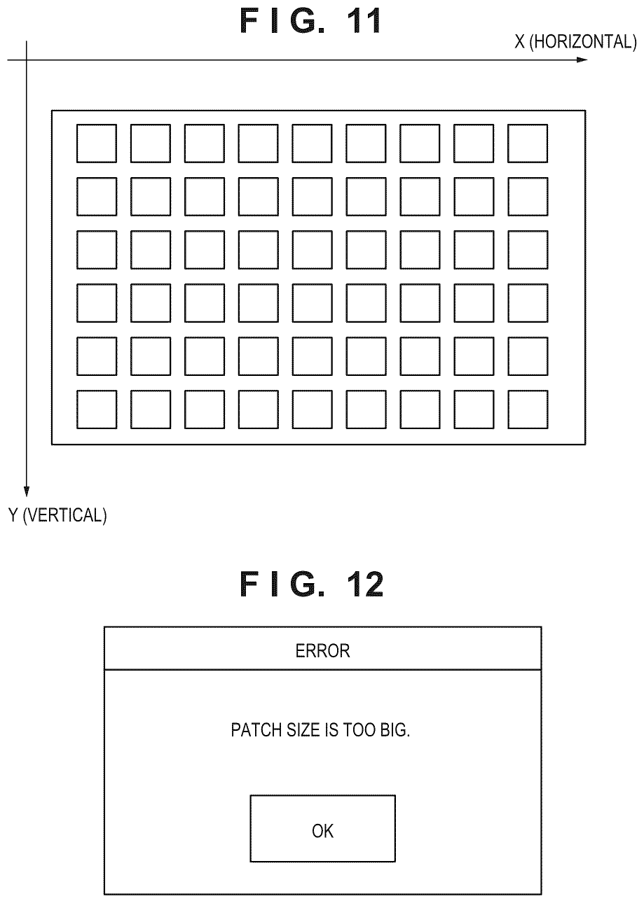

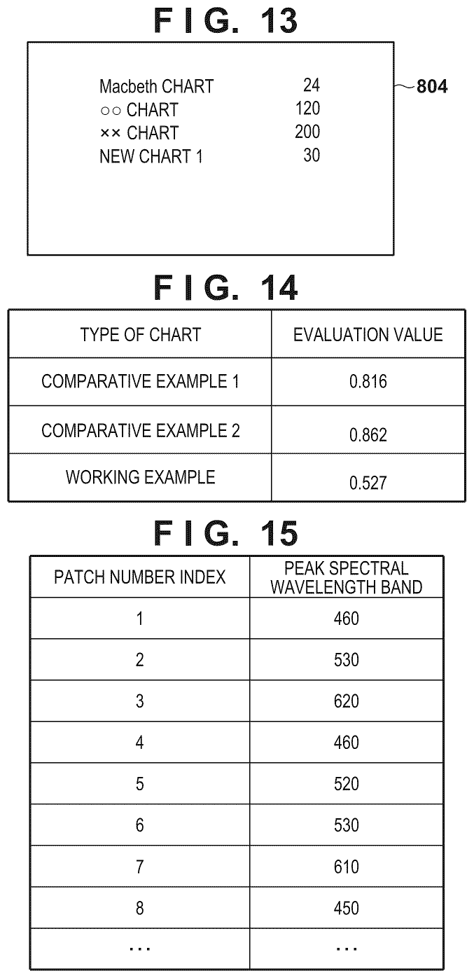

FIG. 10 is a diagram illustrating a user interface (UI) for setting conditions of a color chart to be generated by the image processing apparatus according to a third embodiment. FIG. 11 is a diagram illustrating a relationship between vertical and horizontal directions and XY coordinates of color patch materials according to the third embodiment. FIG. 12 is a diagram illustrating an error display according to the third embodiment. FIG. 13 is a diagram illustrating list of color patch materials after addition of color patch materials according to the third embodiment.

In a main window 800, buttons and dialogs necessary for setting conditions of a color chart, a window for displaying a completion plan diagram of the color chart at the time of completion, and the like are arranged.

A dialog 801 is a field for designating the number of color patch materials in a horizontal direction. A user designates how many color patch materials to arrange in the horizontal direction of the color chart by inputting a numerical value into the dialog 801. Regarding X and Y directions at this time, a horizontal direction (right direction) with respect to the UI is X as illustrated in FIG. 11, and a vertical direction (down direction) is Y. In the example of FIG. 10, nine color patch materials are designated in the X direction and six color patch materials are designated in the Y direction.

A dialog 802 is a field for designating the number of color patch materials in the vertical direction. The user designates how many color patch materials to arrange in the vertical direction of the color chart by inputting a numerical value in the dialog 802.

At this time, if the user inputs a value or the like that is too large for the patch size of the color chart in the dialog 801 or the dialog 802, an error window such as the one illustrated in FIG. 12 will be displayed, and the user is prompted to re-designate the parameter. The error window is displayed not only in the designation of the number of patches in a direction but also if the chart size is exceeded due to a relationship between the patch size and the number of patches when the number of patches is designated, for example.

A dialog 803 is a color chart size designation portion, and a size of one sheet of color chart is designated. The user selects a paper size, such as A4 or B5, in the list of the dialog 803.

A color patch material list 804 is a display portion for a list of color charts that include color patch materials and displays a list of color charts for which color patch materials have been inputted from the input unit 101.

An additionally read color patch button 805 serves as a color patch input portion, and by pressing this, a color chart of color patch materials is additionally read. As illustrated in FIG. 13, the read color chart of color patch materials is registered as a new color chart in a bottom row of the color patch material list 804. Then, the user separately inputs the name of the color chart.

A completion plan diagram display window 806 serves as a design data display portion and displays what kind of arrangement color patch materials will have in the actual color chart based on the designated chart size, patch size, number X of patches in the horizontal direction, and number Y of patches in the vertical direction. At this time, the display is performed assuming that the color patch materials are arranged at equal intervals on the color chart.

An evaluation value display window 807 is a window for displaying the evaluation value E of an expected color chart when a color chart for estimating the spectral characteristics of a camera is generated under the currently-set conditions. For example, “----” is displayed before the selection for the color chart is performed, but after the selection for the color chart has been performed once, an evaluation value such as “0.685” is displayed.

A dialog 808 is a color patch size designation portion, and a size per color patch material is designated. In FIG. 10, the size of one side of one color patch material is designated in units of mm.

A start chart selection button 809 is a button for starting color chart selection processing as to a color chart with what evaluation value will be generated when a color chart is generated under the currently-set conditions.

A pointer 810 is used to select various dialogs and buttons. In the present embodiment, it is operated by a pointing device, such as a mouse, connected to the input I/F 1006.

A start chart generation button 811 is a button for starting generation of a color chart that has the performance of the evaluation value E, under the currently-set conditions. When the user presses the start chart generation button 811, design data is transmitted to the chart generation unit 106, and the chart generation unit 106 generates a color chart. The start chart generation button 811 cannot be pressed unless an evaluation value of the color chart has been generated once by pressing the start chart selection button 809 and will be in a state in which it is grayed out.

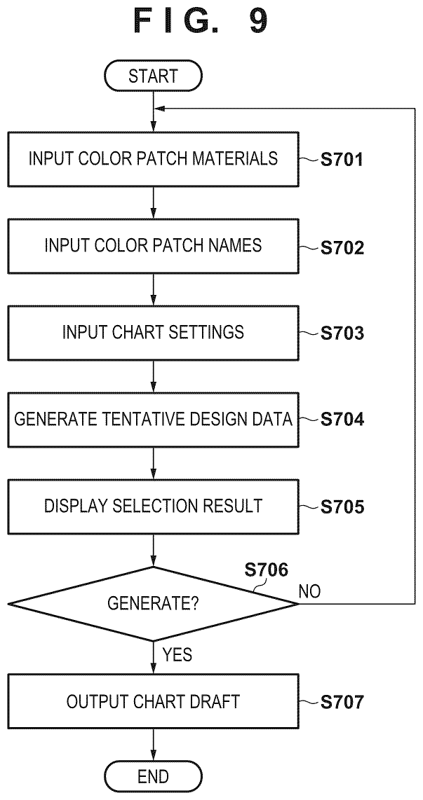

FIG. 9 is a flowchart for explaining an overview of the operation of the image processing apparatus according to the third embodiment.

In step S701, the input unit 101 inputs color patch materials, which are candidates for constituting a color chart.

In step S702, the input unit 101 inputs the names of the color patch materials inputted in step S701.

In step S703, various settings necessary for color chart generation, such as the chart size, the number of patches X, the number of patches Y, and the patch size, are inputted by the user. The order of steps S701 and 703 may be changed. In this case, the respective steps are processed in the order of steps S703, S701, and S702.

In step S704, when the start chart selection button 809 is pressed by the user, the spectral data evaluation unit 104 evaluates whether the pieces of spectral measurement data are suitable for the color chart by calculating the evaluation value E based on the currently-set information and the design data holding unit 105 generates tentative design data based on the evaluation result. The details of processing at this time are similar to those of the first embodiment and second embodiment.

In step S705, the evaluation value E calculated in step S704 is displayed in the evaluation value display window 807, and a result of selection for the color patch materials stored in the tentative design data is reflected in the completion plan diagram display window 806.

In step S706, the user determines whether to generate the currently-selected tentative design data as design data. When the user presses the start chart generation button 811 and performs input for generating the design data, the processing transitions to step S707, and in a case of reviewing the settings again, the processing transitions to step S701.

In step S707, the design data holding unit 105 outputs the generated design data to the chart generation unit 106. The chart generation unit 106 generates and outputs a color chart draft based on the input design data.

As described above, according to the present embodiment, it is possible to generate a color chart for inferring the spectral characteristics of a camera according to user designation.

### Other Embodiments

When it is desired to infer the spectral characteristics of a camera having a narrow color gamut, such as Rec.709, color saturation may occur at the time of imaging with the camera, depending on the coloring materials used in the chart. When the number of patches in which color saturation does not occur is small (e.g., saturation of color in the captured image occurs in 10 of 36 patches), it may be that the spectral characteristics of a camera are not inferred correctly. In response to this, a combination of patches having a small evaluation value E may be additionally selected from patch (coloring material) candidates within a predetermined color gamut, such as Rec.709. For example, in the above case, the total number of patches in the chart is 46.

In the third embodiment, the user manually inputs the color patch material name when inputting a color patch material, but the appearance of a color patch material may be imaged, and the input unit 101 or the spectral data measurement unit 102 may automatically input the color patch material name. In addition, a configuration may be taken so as to set the patch size to a rectangle or another shape instead of a square on the color chart setting UI. Further, a configuration may be taken so as to, after the patch size is designated, automatically calculate and set the number X of color patch materials and the number Y of color patch materials so as to automatically arrange the largest number of color patch materials in the color chart.

In addition, it is conceivable to realize the third embodiment as a computer program that operates on the image processing apparatus 100 disclosed in the present embodiment.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2023-105340, filed Jun. 27, 2023, which is hereby incorporated by reference herein in its entirety.

What is claimed is:

1. An image processing apparatus comprising:
an obtaining unit configured to obtain spectral reflectances of a plurality of color patches; and
a control unit configured to generate design data of a color chart including a plurality of color patches selected so as to reduce an evaluation value E of the color chart calculated based on Equation (I) from the spectral reflectances of the plurality of color patches.
$$\begin{matrix}[ EQUATION I ] & \\ E = \frac{\sum ( \frac{{R}_{m} \cdot {R}_{n}}{\vert {R}_{m} \vert \vert {R}_{n} \vert} )}{{N}^{{C}_{2}}} & ( I )\end{matrix}$$
(Rm, Rn: a spectral reflectance of a color patch whose index number is m, n; N: the number of color patches in the color chart; Σ: a sum of all combinations of m and n)

2. The image processing apparatus according to claim 1, wherein
the plurality of color patches for the color chart are selected such that the evaluation value E is less than or equal to 0.7.

3. The image processing apparatus according to claim 1, wherein
the control unit generates first tentative design data, which includes the selected plurality of color patches, and, in a case where an evaluation value E of second tentative design data to which a color patch not included in the first tentative design data has been added is smaller than an evaluation value E of the first tentative design data, sets the second tentative design data as new tentative design data.

4. The image processing apparatus according to claim 3, wherein
the control unit adds a color patch and updates the tentative design data until the number of color patches of the tentative design data reaches a predetermined number.

5. The image processing apparatus according to claim 4, wherein
the control unit generates a plurality of pieces of tentative design data whose number of color patches is the predetermined number and sets tentative design data whose evaluation value E is the smallest as the design data.

6. The image processing apparatus according to claim 1, wherein
the control unit generates the design data, which includes a plurality of color patches each having a highest reflectance peak in spectral wavelengths greater than or equal to 600 nm.

7. The image processing apparatus according to claim 1, wherein
the control unit generates the design data, which includes a plurality of color patch materials each having a highest reflectance peak in spectral wavelengths from 500 nm to 540 nm.

8. The image processing apparatus according to claim 1, wherein
the control unit generates the design data, which includes a plurality of color patch materials each having a highest reflectance peak in spectral wavelengths from 440 nm to 470 nm.

9. The image processing apparatus according to claim 1, wherein
the control unit generates the design data based on the number of a plurality of color patches to be arranged in the color chart inputted by a user.

10. The image processing apparatus according to claim 9, wherein
the control unit generates the design data based on a size of the color chart inputted by a user.

11. The image processing apparatus according to claim 10, wherein
in a case where the size of the color chart is not compatible with the number of the selected plurality of color patches, the control unit outputs an error.

12. The image processing apparatus according to claim 1, wherein
the control unit displays the color chart including the selected plurality of color patches.

13. The image processing apparatus according to claim 1, wherein
the control unit displays a completion plan diagram of the color chart including the selected plurality of color patches.

14. A method of controlling an image processing apparatus, the method comprising:
obtaining spectral reflectances of a plurality of color patches; and
generating design data of a color chart including a plurality of color patches selected so as to reduce an evaluation value E of the color chart calculated based on Equation (I) from the spectral reflectances of the plurality of color patches.
$$\begin{matrix}[ EQUATION I ] & \\ E = \frac{\sum ( \frac{{R}_{m} \cdot {R}_{n}}{\vert {R}_{m} \vert \vert {R}_{n} \vert} )}{{N}^{{C}_{2}}} & ( I )\end{matrix}$$
(Rm, Rn: a spectral reflectance of a color patch whose index number is m, n; N: the number of color patches in the color chart; Σ: a sum of all combinations of m and n)

15. A non-transitory computer-readable storage medium storing a computer program to be read and executed by a computer to cause the computer to:
obtain spectral reflectances of a plurality of color patches; and
generate design data of a color chart including a plurality of color patches selected so as to reduce an evaluation value E of the color chart calculated based on Equation (I) from the spectral reflectances of the plurality of color patches.
(Rm, Rn: a spectral reflectance of a color patch whose index number is m, n; N: the number of color patches in the color chart; Σ: a sum of all combinations of m and n)
$$\begin{matrix}[ EQUATION I ] & \\ E = \frac{\sum ( \frac{{R}_{m} \cdot {R}_{n}}{\vert {R}_{m} \vert \vert {R}_{n} \vert} )}{{N}^{{C}_{2}}} & ( I )\end{matrix}$$

16. A color chart including a plurality of color patches and whose evaluation value E calculated based on Equation (1) from spectral reflectances of the plurality of color patches is less than or equal to 0.7.
$$\begin{matrix}[ EQUATION I ] & \\ E = \frac{\sum ( \frac{{R}_{m} \cdot {R}_{n}}{\vert {R}_{m} \vert \vert {R}_{n} \vert} )}{{N}^{{C}_{2}}} & ( I )\end{matrix}$$
(Rm, Rn: a spectral reflectance of a color patch whose index number is m, n; N: the number of color patches in the color chart; Σ: a sum of all combinations of m and n)
